(19) United States
(12) Patent Application Publication
(10) Pub. No.: US 2020/0235349 A1
(43) Pub. Date: Jul. 23, 2020

(54) BATTERY PACKAGING MATERIAL

(71) Applicant: WONIK BM TECH CO., LTD., Seongnam (KR)

(72) Inventors: Changill HONG, Cheonan (KR); Soonhee HONG, Cheonan (KR)

(21) Appl. No.: 16/743,845

(22) Filed: Jan. 15, 2020

(30) Foreign Application Priority Data
Jan. 22, 2019 (KR) 10-2019-0008252

(51) Int. Cl. H01M 2/02

(52) U.S. Cl. CPC H01M 2/0287; H01M 2/0277; H01M 2/0285

(57) ABSTRACT

A battery packaging material is provided. The battery packaging material comprises a protective layer, and a layer structure disposed on the protective layer and comprising one layer or two or more layers. The protective layer comprises an adhesive polymer compound comprising following formula 1.

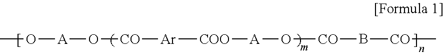

W In formula 1, Ar represents a benzene ring, and each of A and B represents a hydrocarbon group whose carbon number is 2 to 9.

### BACKGROUND OF THE INVENTION

### 1. Field of the Invention

The present invention relates to a battery packaging material.

### 2. Description of the Related Art

A battery packaging material is used in order to seal a battery including an electrode and an electrolyte. Since batteries are manufactured in various shapes in order to be used in various products such as electric vehicles, computers and cameras, it is necessary for the battery packaging material to be processed into various shapes. However, it is difficult for a conventional battery packaging material to be processed into various shapes. In particular, in the case of a battery packaging material made of metal, an electrolyte of a battery permeates into a metal layer and thus may cause battery defects such as metal precipitation, etc.

### SUMMARY OF THE INVENTION

In order to solve the above mentioned problems, the present invention provides a battery packaging material having excellent performance.

The other objects of the present invention will be clearly understood with reference to the following detailed description and the accompanying drawings.

A battery packaging material according to embodiments of the present invention comprises a protective layer, and a layer structure disposed on the protective layer and comprising one layer or two or more layers. The protective layer comprises an adhesive polymer compound comprising following formula 1.

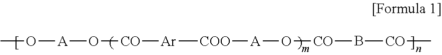

In formula 1, Ar represents a benzene ring, and each of A and B represents a hydrocarbon group whose carbon number is 2 to 9.

A battery packaging material according to embodiments of the present invention comprises a protective layer, and a layer structure disposed on the protective layer and comprising one layer or two or more layers. The protective layer is formed of an adhesive resin composition, the adhesive resin composition comprises polypropylene, modified polypropylene, rubber, petroleum resin and an adhesive polymer compound, and the adhesive polymer compound comprises following formula 1.

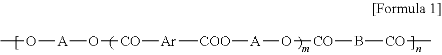

In formula 1, Ar represents a benzene ring, and each of A and B represents a hydrocarbon group whose carbon number is 2 to 9.

A battery packaging material according to embodiments of the present invention can have excellent performance. For example, the battery packaging material has excellent electrolyte resistance and processability.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows a battery packaging material according to one embodiment of the present invention.

FIG. 2 shows a battery packaging material according to another embodiment of the present invention.

### DESCRIPTION OF SPECIFIC EMBODIMENTS

Hereinafter, a detailed description will be given of the present invention with reference to the following embodiments. The purposes, features, and advantages of the present invention will be easily understood through the following embodiments. The present invention is not limited to such embodiments, but may be modified in other forms. The embodiments to be described below are nothing but the ones provided to bring the disclosure of the present invention to perfection and assist those skilled in the art to completely understand the present invention. Therefore, the following embodiments are not to be construed as limiting the present invention.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. It will be understood that when an element is referred to as being “on” another element, it can be directly on the other element or intervening elements may be present therebetween.

The size of the element or the relative sizes between elements in the drawings may be shown to be exaggerated for more clear understanding of the present invention. In addition, the shape of the elements shown in the drawings may be somewhat changed by variation of the manufacturing process or the like. Accordingly, the embodiments disclosed herein are not to be limited to the shapes shown in the drawings unless otherwise stated, and it is to be understood to include a certain amount of variation.

A battery packaging material according to embodiments of the present invention comprises a protective layer, and a layer structure disposed on the protective layer and comprising one layer or two or more layers. The protective layer comprises an adhesive polymer compound comprising following formula 1.

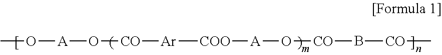

In formula 1, Ar represents a benzene ring, and each of A and B represents a hydrocarbon group whose carbon number is 2 to 9.

In the formula 1, —Ar— may represent at least any one of

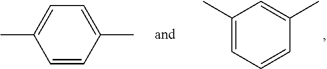

-A- may represent —(CH₂)ₐ— (a is an integer of 2 or more and 9 or less), and —B— may represent —(CH₂)_{b}— (b is an integer of 2 or more and 9 or less).

A ratio of

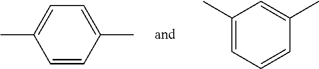

may be 1:1˜10:1 in the formula 1.

In the formula 1, -A- may represent at least any one of —(CH₂)₂—, —(CH₂)₃— and —(CH₂)₄—, and —B— may represent at least any one of —(CH₂)₂— and —(CH₂)₄—.

In the formula 1, molecular weight of a portion corresponding to following formula 3 may be 1,000˜10,000.

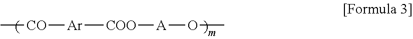

Molecular weight of the adhesive polymer compound may be 100,000˜200,000.

The layer structure may comprise a metal layer. The metal layer may comprise aluminum. A surface of the metal layer may be treated by chrome. The metal layer may be in contact with the protective layer.

The layer structure may further comprise a first adhesive layer disposed on the metal layer and a first polymer layer disposed on the first adhesive layer. The first polymer layer may comprise nylon. The layer structure may further comprise a second adhesive layer disposed on the first polymer layer and a second polymer layer disposed on the second adhesive layer. The second polymer layer may comprise PET.

A battery packaging material according to embodiments of the present invention comprises a protective layer, and a layer structure disposed on the protective layer and comprising one layer or two or more layers.

The protective layer is formed of an adhesive resin composition, and the adhesive resin composition comprises polypropylene, modified polypropylene, rubber, petroleum resin and an adhesive polymer compound.

The adhesive resin composition may comprise 30˜80 parts by weight of the polypropylene, 3˜15 parts by weight of the modified polypropylene, 10˜30 parts by weight of the rubber, 3˜20 parts by weight of the petroleum resin and 3˜12 parts by weight of the adhesive polymer compound.

The adhesive resin composition may further comprise a flame retardant. The adhesive resin composition may comprise 1˜15 parts by weight of the flame retardant.

The polypropylene may have a melt index of 1˜10 g/10 minutes (230° C., 2.16 kg), the modified polypropylene may have a melt index of 10˜100 g/10 minutes (230° C., 2.16 kg), the rubber may have a melt index of 0.05˜10 g/10 minutes (190° C., 2.16 kg), the adhesive polymer compound may have a melt index of 1˜15 g/10 minutes (190° C., 2.16 kg). In addition, the adhesive resin composition may have a melt index of 5˜15 g/10 minutes (230° C., 2.16 kg).

The modified polypropylene may be formed by a graft of a maleic acid onto polypropylene.

The rubber may comprise EPR (Ethylene Propylene Rubber), EBR (Ethylene Butene Rubber), EOR (Ethylene Octene Rubber) or a combination thereof.

The petroleum resin may comprise C5 petroleum resin, C9 petroleum resin or a combination thereof.

The adhesive polymer compound comprises following formula 1.

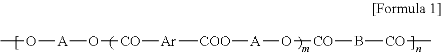

In formula 1, Ar represents a benzene ring, and each of A and B represents a hydrocarbon group whose carbon number is 2 to 9.

In the formula 1, —Ar— may represent at least any one of

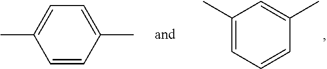

-A- may represent —(CH₂)ₐ— (a is an integer of 2 or more and 9 or less), and —B— may represent —(CH₂)_{b}— (b is an integer of 2 or more and 9 or less).

A ratio of

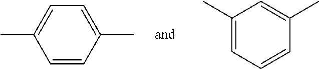

may be 1:1˜10:1 in the formula 1.

In the formula 1, -A- may represent at least any one of —(CH₂)₂—, —(CH₂)₃— and —(CH₂)₄—, and —B— may represent at least any one of —(CH₂)₂— and —(CH₂)₄—.

In the formula 1, molecular weight of a portion corresponding to following formula 3 may be 1,000˜10,000.

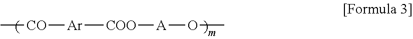

Molecular weight of the adhesive polymer compound may be 100,000˜200,000.

The layer structure may comprise a metal layer. The metal layer may comprise aluminum. A surface of the metal layer may be treated by chrome. The metal layer may be in contact with the protective layer.

The layer structure may further comprise a first adhesive layer disposed on the metal layer and a first polymer layer disposed on the first adhesive layer. The first polymer layer may comprise nylon. The layer structure may further comprise a second adhesive layer disposed on the first polymer layer and a second polymer layer disposed on the second adhesive layer. The second polymer layer may comprise PET.

A method of forming a battery packaging material according to embodiments of the present invention comprises a step of forming a layer structure comprising one layer or two or more layers and a step of bonding a protective layer to the layer structure.

In one embodiment of the present invention, the step of forming the layer structure may comprise a step of stacking a metal layer, a first adhesive layer and a first polymer layer. In another embodiment of the present invention, the step of forming the layer structure may comprise a step of stacking a metal layer, a first adhesive layer, a first polymer layer, a second adhesive layer and a second polymer layer.

For example, the metal layer may be formed of aluminum, the first polymer layer may be formed of nylon, the second polymer layer may be formed of PET, and the first adhesive layer and the second adhesive layer may be formed of polyurethane. The metal layer and the first polymer layer may be bonded to each other by the first adhesive layer, and the first polymer layer and the second polymer layer may be bonded to each other by the second adhesive layer.

Before forming the layer structure, a surface of the metal layer may be treated with chrome, etc. For example, the surface treatment may be performed by placing the metal layer in a nitric acid solution or a sodium hydroxide solution to remove foreign substances from the surface, washing it with water, and then adding it to a solution containing chrome ions. The metal layer is washed with water and then dried.

The protective layer may be formed by performing an extrusion coating of an adhesive resin composition on the metal layer of the layer structure. The adhesive resin composition comprises polypropylene, modified polypropylene, rubber, petroleum resin and adhesive polymer compound.

The adhesive resin composition may comprise 30˜80 parts by weight of the polypropylene, 3˜15 parts by weight of the modified polypropylene, 10˜30 parts by weight of the rubber, 3˜20 parts by weight of the petroleum resin and 3˜12 parts by weight of the adhesive polymer compound.

The adhesive resin composition may further comprise a flame retardant. The adhesive resin composition may comprise 1˜15 parts by weight of the flame retardant.

The polypropylene may have a melt index of 1˜10 g/10 minutes (230° C., 2.16 kg), the modified polypropylene may have a melt index of 10˜100 g/10 minutes (230° C., 2.16 kg), the rubber may have a melt index of 0.05˜10 g/10 minutes (190° C., 2.16 kg), the adhesive polymer compound may have a melt index of 1˜15 g/10 minutes (190° C., 2.16 kg). In addition, the adhesive resin composition may have a melt index of 5˜15 g/10 minutes (230° C., 2.16 kg).

The modified polypropylene may be formed by a graft of a maleic acid onto polypropylene.

The rubber may comprise EPR (Ethylene Propylene Rubber), EBR (Ethylene Butene Rubber), EOR (Ethylene Octene Rubber) or a combination thereof.

The petroleum resin may comprise C5 petroleum resin, C9 petroleum resin or a combination thereof.

The adhesive polymer compound comprises following formula 1.

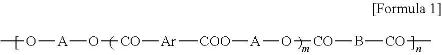

In formula 1, Ar represents a benzene ring, and each of A and B represents a hydrocarbon group whose carbon number is 2 to 9.

In the formula 1, —Ar— may represent at least any one of

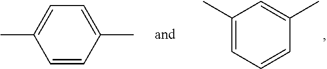

-A- may represent —(CH₂)ₐ— (a is an integer of 2 or more and 9 or less), and —B— may represent —(CH₂)_{b}— 6 (b is an integer of 2 or more and 9 or less).

In the formula 1, a ratio of

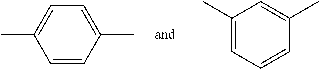

may be 1:1˜10:1.

In the formula 1, -A- may represent at least any one of —(CH₂)₂—, —(CH₂)₃— and —(CH₂)₄—, and —B— may represent at least any one of —(CH₂)₂— and —(CH₂)₄—.

In the formula 1, molecular weight of a portion corresponding to following formula 3 may be 1,000˜10,000.

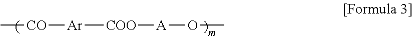

Molecular weight of the adhesive polymer compound may be 100,000˜200,000.

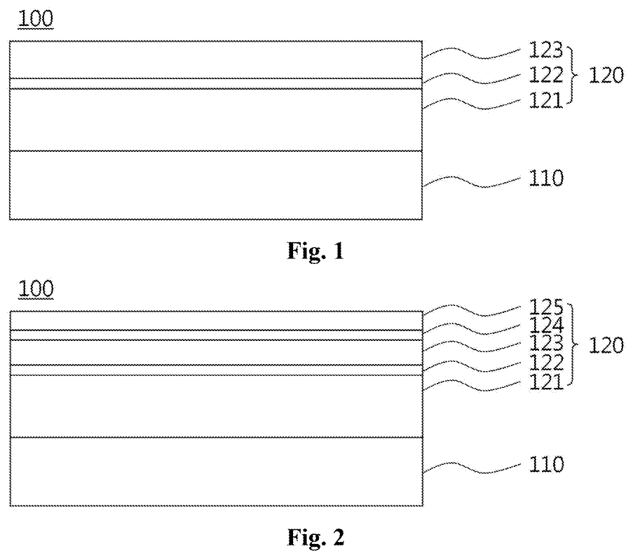

FIG. 1 shows a battery packaging material according to one embodiment of the present invention.

Referring to FIG. 1, the battery packaging material 10 may comprise a protective layer 110 and a layer structure 120. The layer structure 120 may comprise a metal layer 121, an adhesive layer 122 and a polymer layer 123. The layer structure 120 may be formed by stacking the metal layer 121, the adhesive layer 122 and the polymer layer 123. For example, the layer structure 120 may be formed by bonding the polymer layer 123 to the metal layer 121 using the adhesive layer 122. For example, the metal layer 121 may be formed of aluminum, the adhesive layer 122 may be formed of polyurethane and the polymer layer 123 may be formed of nylon. The metal layer 121 may have a thickness of about 40 μm, the adhesive layer 122 may have a thickness of about 3 μm, and the polymer layer 123 may have a thickness of about 25 μm.

Before forming the layer structure 120, a surface of the metal layer 121 may be treated with chrome, etc. For example, the surface treatment may be performed by placing the metal layer 121 in a nitric acid solution or a sodium hydroxide solution to remove foreign substances from the surface, washing it with water, and then adding it to a solution containing chrome ions. The metal layer 121 is washed with water and then dried.

The protective layer 110 may be formed by performing an extrusion coating of an adhesive resin composition on the metal layer 121 of the layer structure 120. The protective layer 110 may have a thickness of about 45 μm.

The adhesive resin composition comprises polypropylene, modified polypropylene, rubber, petroleum resin and adhesive polymer compound. It is preferable that the adhesive resin composition comprises 30˜80 parts by weight of the polypropylene, 3˜15 parts by weight of the modified polypropylene, 10˜30 parts by weight of the rubber, 3˜20 parts by weight of the petroleum resin and 3˜12 parts by weight of the adhesive polymer compound.

The adhesive resin composition may further comprise a flame retardant. The adhesive resin composition may comprise 1˜15 parts by weight of the flame retardant.

If the content of the polypropylene is less than 30 parts by weight, the heat resistance of the adhesive resin composition may be lowered. If the content of the polypropylene is greater than 80 parts by weight, the adhesiveness of the adhesive resin composition may be lowered.

If the content of the modified polypropylene is less than 3 parts by weight, the adhesiveness of the adhesive resin composition may be lowered. If the content of the modified polypropylene is greater than 15 parts by weight, the flowability of the adhesive resin composition may be increased to lower the uniformity of a coating.

If the content of the rubber is less than 10 parts by weight, the adhesiveness of the adhesive resin composition may be lowered. If the content of the rubber is greater than 30 parts by weight, the heat resistance of the adhesive resin composition may be lowered.

If the content of the petroleum resin is less than 3 parts by weight, the adhesiveness of the adhesive resin composition may be lowered. If the content of the petroleum resin is greater than 20 parts by weight, the surface of a adhesive film formed by the adhesive resin composition may be sticky.

If the content of the flame retardant is less than 1 part by weight, the flame retardant effect may be lowered. If the content of the flame retardant is greater than 15 parts by weight, the film formability may be lowered.

If the content of the adhesive polymer compound is less than 3 parts by weight, the adhesiveness of the adhesive resin composition may be lowered. If the content of the adhesive polymer compound is greater than 12 parts by weight, the compatibility with the polypropylene may be lowered.

The adhesive resin composition may further comprise additives such as a heat stabilizer, a slip agent, a neutralizing agent and the like according to a use or a process method.

The adhesive resin composition may have a melt index of 5˜15 g/10 minutes (230° C., 2.16 kg).

The polypropylene may comprise homo polypropylene, random polypropylene, ter polypropylene or a combination thereof. The polypropylene may have a melting temperature of 130˜164° C. If the melting temperature of the polypropylene is lower than 130° C., the weather resistance of the product manufactured by an extrusion coating of the adhesive resin composition may be lowered. If the melting temperature of the polypropylene is higher than 164° C., the adhesiveness of the adhesive resin composition may be lowered. The polypropylene may have a melt index of 1˜10 g/10 minutes (230° C., 2.16 kg).

The modified polypropylene may be formed by a graft of a maleic acid onto polypropylene. The modified polypropylene may have a density of 0.90 g/cm³ or less. The modified polypropylene may have a melt index of 10˜100 g/10 minutes (230° C., 2.16 kg).

The rubber may comprise EPR (Ethylene Propylene Rubber), EBR (Ethylene Butene Rubber), EOR (Ethylene Octene Rubber) or a combination thereof. The rubber may have a density of 0.89 g/cm³ or less. The rubber may have a melt index of 0.05˜10 g/10 minutes (190° C., 2.16 kg).

The petroleum resin may comprise C5 petroleum resin, C9 petroleum resin or a combination thereof.

The flame retardant may comprise a halogen based flame retardant, an inorganic flame retardant, a phosphorus based flame retardant or a combination thereof.

The adhesive polymer compound comprises following formula 1.

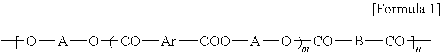

In formula 1, Ar represents a benzene ring, and each of A and B represents a hydrocarbon group whose carbon number is 2 to 9.

In the formula 1, —Ar— may represent at least any one of

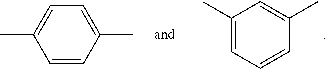

It is preferable that the adhesive polymer compound may comprise both

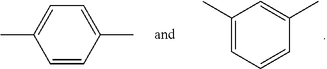

In the adhesive polymer compound, if the content of

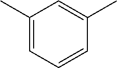

is increased with respect to

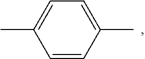

the adhesive strength of the adhesive polymer compound may increase but the melting point may decrease. Therefore, the contents of

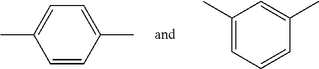

may be determined in consideration of the adhesive strength and the melting point of the adhesive polymer compound. The ratio of

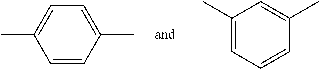

may be 1:1˜10:1. It is preferable that the ratio of

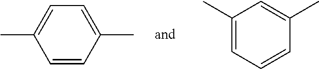

is 3:1˜7:1.

In the formula 1, -A- may represent —(CH₂)ₐ— (a is an integer of 2 or more and 9 or less). For example, -A- may represent at least any one of —(CH₂)₂—, —(CH₂)₃— and —(CH₂)₄—. —B— may represent —(CH₂)_{b}— (b is an integer of 2 or more and 9 or less). For example, —B— may represent at least any one of —(CH₂)₂— and —(CH₂)₄—.

In the formula 1, molecular weight of a portion corresponding to following formula 3 may be 1,000˜10,000.

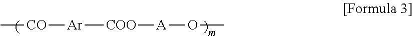

The molecular weight of the adhesive polymer compound may be 100,000˜200,000. The adhesive polymer compound may have a density of 1.0˜1.5 g/cm³. It is preferable that the adhesive polymer compound has a density of 1.2˜1.3 g/cm³. The adhesive polymer compound may have a melting temperature of 70˜145° C.

The adhesive polymer compound may have an excellent adhesive property. For example, the adhesive polymer compound may have an excellent hot melt adhesive property.

The method for preparing an adhesive polymer compound comprises the step of forming a first polymerization compound by polymerizing (a first polymerization reaction) a phthalate compound having following formula 4 and a diol compound having following formula 5, and the step of forming a second polymerization compound by polymerizing (a second polymerization reaction) the first polymerization compound and a dicarboxylic acid compound having following formula 6.

R¹OOC—Ar—COOR² [Formula 4]

HO-A-OH [Formula 5]

HOOC—B—COOH [Formula 6]

In formulas 4 to 6, Ar represents a benzene ring, R¹ and R² represent an alkyl group whose carbon number is 1 to 9, and each of A and B represents a hydrocarbon group whose carbon number is 2 to 9.

The method of preparing the adhesive polymer compound may further comprise the step of performing a polymerization reaction (a third polymerization reaction) to increase the molecular weight of the second polymerization compound.

In formulas 4 to 6, —Ar— may represent at least any one of

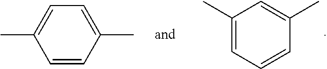

-A- may represent —(CH₂)ₐ— (a is an integer of 2 or more and 9 or less). For example, -A- may represent at least any one of —(CH₂)₂—, —(CH₂)₃— and —(CH₂)₄—. —B— may represent —(CH₂)_{b}— (b is an integer of 2 or more and 9 or less). For example, —B— may represent at least any one of —(CH₂)₂— and —(CH₂)₄—.

The phthalate compound may comprise at least any one of a terephthalate compound and an isophthalate compound. It is preferable that the phthalate compound comprises both the terephthalate compound and the isophthalate compound. If the amount of the isophthalate compound is increased with respect to the terephthalate compound, the adhesive strength of the adhesive polymer compound to be formed may increase but the melting point may decrease. Therefore, the amounts of the terephthalate compound and the isophthalate compound may be determined in consideration of the adhesive strength and the melting point of the adhesive polymer compound. The mole ratio of the terephthalate compound and the isophthalate compound may be 1:1˜10:1. It is preferable that the ratio of the terephthalate compound and the isophthalate compound is 3:1˜7:1.

The phthalate compound may comprise at least any one of dimethyl terephthalate and dimethyl isophthalate. It is preferable that the phthalate compound comprises both dimethyl terephthalate and dimethyl isophthalate. The diol compound may comprise at least any one of ethanediol, propanediol, and butanediol. The dicarboxylic acid compound may comprise at least any one of succinic acid and adipic acid.

In order that there is no unreacted residue of the phthalate compound, it is preferable that the diol compound is added more than the number of moles needed to react with the phthalate compound.

The first polymerization compound may have following formula 2.

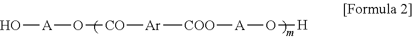

In formula 2, Ar represents a benzene ring and A represents a hydrocarbon group whose carbon number is 2 to 9. —Ar— may represent at least any one of

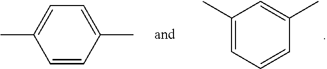

-A- may represents —(CH₂)ₐ— (a is an integer of 2 or more and 9 or less). For example, -A- may represent at least any one of —(CH₂)₂—, —(CH₂)₃— and —(CH₂)₄—.

The first polymerization compound may comprise following formula 3, and the second polymerization compound may comprise following formula 1.

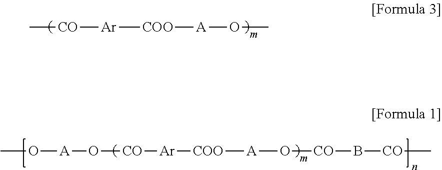

In formulas 1 and 3, Ar represents a benzene ring, and each of A and B represents a hydrocarbon group whose carbon number is 2 to 9. —Ar— may represent at least any one of

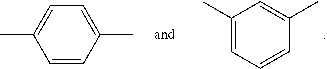

-A- may represent —(CH₂)ₐ— (a is an integer of 2 or more and 9 or less). For example, -A- may represent at least any one of —(CH₂)₂—, —(CH₂)₃— and —(CH₂)₄—. —B— may represent —(CH₂)_{b}— (b is an integer of 2 or more and 9 or less). For example, —B— may represent at least any one of —(CH₂)₂— and —(CH₂)₄—.

The step of forming the first polymerization compound may comprise the step of mixing the phthalate compound, the diol compound and a first catalyst. The first catalyst may comprise TNBT (Tetra-n-butyltitanate).

The step of forming the second polymerization compound may comprise mixing the first polymerization compound, the dicarboxylic acid compound and a second catalyst. The second catalyst may comprise TNBT and TPP (Triphenylphosphate)

The step of performing a polymerization reaction to increase the molecular weight of the second polymerization compound may comprise the step of mixing the second polymerization compound and a third catalyst. The third catalyst may comprise TNBT, ZA (Zinc acetate) and TMP (trimethylphosphine).

The first to third polymerization reactions may be performed at 180˜250° C. For example, the first polymerization reaction and the second polymerization reaction may be performed at 190° C., and the third polymerization reaction may be performed at 220° C. In addition, the third polymerization reaction may be performed at 190° C. and then performed at the changed temperature of 220° C.

The molecular weight of the first polymerization compound may be 1,000˜10,000, the molecular weight of the second polymerization compound may be 10,000˜100,000, and the molecular weight of the adhesive polymer compound may be 100,000˜200,000.

An example for preparing the adhesive polymer compound is as follows.

1,4-butanediol, dimethyl terephthalate, dimethyl isophthalate as a reactant and TNBT (Tetra-n-butyltitanate) as a catalyst are sequentially added into a reactor. The dimethyl terephthalate and the dimethyl isophthalate are added at a mole ratio of 5:1. In order that there is no unreacted residue of the dimethyl terephthalate and the dimethyl isophthalate, it is preferable that the 1,4-butanediol is added more than the number of moles needed to react with the dimethyl terephthalate and the dimethyl isophthalate. For example, the dimethyl terephthalate and the dimethyl isophthalate are added by 17.48 kg and 3.5 kg, respectively, and the 1,4-butanediol is added by 21.9 kg. The TNBT is added by 27 g. The temperature of the reactor is set to 190° C. before the addition of the reactants and the catalyst.

A stirrer in the reactor is operated and the rotation speed of the stirrer gradually increases to 100 rpm. The reactants are polymerized (a first polymerization reaction) by the catalyst to form a first polymerization compound having following formula 7.

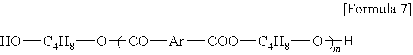

In formula 7, —Ar— represents

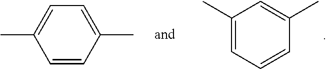

The first polymerization compound comprises following formula 8.

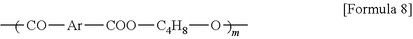

In formula 8, —Ar— represents

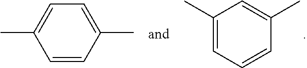

The first polymerization compound may be an oligomer having the molecular weight of 1,000˜10,000. In addition, the first polymerization compound may be in a transparent liquid state at 190° C.

When the reactants react to form the first polymerization compound, methanol is produced. The produced methanol is discharged through a column connected to the top portion of the reactor. The amount of the discharged methanol can be identified through the column. Termination of the polymerization reaction may be determined through the amount of the discharged methanol and/or the temperature of the column.

After the termination of the polymerization reaction, adipic acid as a reactant and TPP (Triphenylphosphate), TNBT as a catalyst are sequentially introduced into the reactor. The adipic acid is added by 10.52 kg, the TPP is added by 18 g, and the TNBT is added by 38 g.

The stirrer in the reactor is operated and the rotation speed of the stirrer gradually increases to 100 rpm. The first polymerization compound and the adipic acid are polymerized (a second polymerization reaction) by the catalyst to form a second polymerization compound comprising following formula 9.

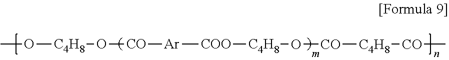

In formula 9, —Ar— represents

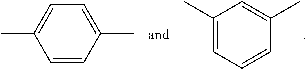

The second polymerization compound may have the molecular weight of 10,000˜100,000.

When the first polymerization compound reacts with the adipic acid to form the second polymerization compound, water is produced. The produced water is discharged through the column connected to the top portion of the reactor. The amount of the discharged water can be identified through the column. Termination of the polymerization reaction may be determined through the amount of the discharged water and/or the temperature of the column.

After the termination of the polymerization reaction, ZA (Zinc acetate), TMP (Trimethylphosphine) and TNBT which are catalysts are sequentially added into the reactor. The ZA is added by 18 g, the TMP is added by 25 g, and the TNBT is by 38 g.

The stirrer in the reactor is operated and the rotation speed of the stirrer gradually increases to 100 rpm. The second polymerization compound is polymerized (a third polymerization reaction) by the catalyst so that the molecular weight is increased and an adhesive polymer compound is formed. The adhesive polymer compound may comprise the formula 9 and may have the molecular weight of 100,000˜200,000.

By controlling the rotation speed of the stirrer, the molecular weight and the melt flow index (MFI) of the adhesive polymer compound can be controlled. For example, the rotational speed of the stirrer may decrease from 100 rpm to 15 rpm, increase to 35 rpm and be maintained at that speed, and then gradually increase to 95 rpm. In addition, the temperature of the reactor may be changed from 190° C. to 220° C.

Unlike the above mentioned preparation example, the third polymerization reaction may be terminated in a separate reactor. When the third polymerization reaction is stabilized 10 minutes or so after adding the catalyst to the reactor (a first reactor), the mixture in the first reactor is transferred to another reactor (a second reactor) connected to the first reactor. At this time, the rotation speed of the stirrer in the first reactor decreases from 100 rpm to 15 rpm. Unnecessary gases and the like inside the second reactor are removed using a vacuum pump before transferring the mixture, and the temperature of the second reactor is set to 220° C. The molecular weight and the melt flow index (MFI) of the adhesive polymer compound may be controlled by controlling the rotation speed of the stirrer in the second reactor. For example, when the mixture is transferred to the second reactor, the rotation speed of the stirrer in the second reactor may be maintained at 35 rpm and gradually increase to 95 rpm.

In the above embodiment described with reference to FIG. 1, the protective layer 110 is formed of the adhesive resin composition, but is not limited thereto. The protective layer 110 may be formed by another method different from the extrusion coating. The protective layer 110 may be formed by another resin composition whose component is different from that of the adhesive resin composition. The protective layer 110 may be formed so as to comprise an adhesive polymer compound comprising the formula 1.

FIG. 2 shows a battery packaging material according to another embodiment of the present invention.

Referring to FIG. 2, the battery packaging material 10 may comprise a protective layer 110 and a layer structure 120. The layer structure 120 may comprise a metal layer 121, a first adhesive layer 122, a first polymer layer 123, a second adhesive layer 124 and a second polymer layer 125. The layer structure 120 may be formed by stacking the metal layer 121, the first adhesive layer 122, the first polymer layer 123, the second adhesive layer 124 and the second polymer layer 125. For example, the layer structure 120 may be formed by bonding the first polymer layer 123 to the metal layer 121 using the first adhesive layer 122 and then bonding the second polymer layer 125 to the first polymer layer 123 using the second adhesive layer 124. For example, the metal layer 121 may be formed of aluminum, the first polymer layer 123 may be formed of nylon, the second polymer layer 125 may be formed of PET, and the first adhesive layer 122 and the second adhesive layer 124 may be formed of polyurethane.

The metal layer 121 may have a thickness of about 40 μm, the first polymer layer 123 may have a thickness of about 15 μm, the second polymer layer 125 may have a thickness of about 12 μm, and each of the first adhesive layer 122 and the second adhesive layer 124 may have a thickness of about 3 μm.

Before forming the layer structure 120, a surface of the metal layer 121 may be treated with chrome, etc. For example, the surface treatment may be performed by placing the metal layer 121 in a nitric acid solution or a sodium hydroxide solution to remove foreign substances from the surface, washing it with water, and then adding it to a solution containing chrome ions. The metal layer 121 is washed with water and then dried.

The protective layer 110 can be formed by performing an extrusion coating of an adhesive resin composition on the metal layer 121 of the layer structure 120. Regarding the protective layer 110, since what is explained with reference to FIG. 1 can be applied, the detailed description thereof will be omitted herein.

The protective layer of the battery packaging material according to embodiments of the present invention may be formed by mixing the components of the adhesive resin composition and then performing extruding. The mixing may be performed using a kneading machine such as a kneader, a roll mill, a banbury mixer. The extrusion may be performed using single screw extruder or twin screw extruder. For example, the extrusion coating of the adhesive resin composition may be performed by a T-die method so that the adhesive resin is formed into a protective layer. The adhesive resin composition is excellent in adhesive property and processability. For example, the adhesive resin composition is excellent in adhesive strength to aluminum and can easily adjust processability.

### EXAMPLE

### Example 1

Regarding 77 kg of polypropylene with a melt index of 5 g/10 minutes (230° C., 2.16 kg), 5 kg of modified polypropylene with a melt index of 20 g/10 minutes (230° C., 2.16 kg) which is formed by a graft of a maleic acid, 10 kg of EOR (Ethylene Octene Rubber) with a melt index of 1 g/10 minutes (190° C., 2.16 kg) and a density of 0.89 g/cm³, 5 kg of petroleum resin, and 3 kg of an adhesive polymer compound (a ratio of

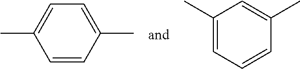

is 5:1) comprising the formula 9, roll mixing milling and extrusion are performed to prepare an adhesive resin composition with a melt index of 10 g/10 minutes (230° C., 2.16 kg). The extrusion coating of the adhesive resin composition is performed on an aluminum layer (aluminum film) at a temperature of 230° C. by a T-die method to form a protective layer (protection film).

### Example 2

Regarding 56 kg of polypropylene with a melt index of 5 g/10 minutes (230° C., 2.16 kg), 7 kg of modified polypropylene with a melt index of 20 g/10 minutes (230° C., 2.16 kg) which is formed by a graft of a maleic acid, 25 kg of EOR (Ethylene Octene Rubber) with a melt index of 1 g/10 minutes (190° C., 2.16 kg) and a density of 0.89 g/cm³, 7 kg of petroleum resin, and 5 kg of an adhesive polymer compound (a ratio of

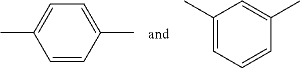

is 5:1) comprising the formula 9, roll mixing milling and extrusion are performed to prepare an adhesive resin composition with a melt index of 12 g/10 minutes (230° C., 2.16 kg). The extrusion coating of the adhesive resin composition is performed on an aluminum layer at a temperature of 230° C. by a T-die method to form a protective layer.

### Example 3

Regarding 65 kg of polypropylene with a melt index of 5 g/10 minutes (230° C., 2.16 kg), 8 kg of modified polypropylene with a melt index of 20 g/10 minutes (230° C., 2.16 kg) which is formed by a graft of a maleic acid, 15 kg of EOR (Ethylene Octene Rubber) with a melt index of 1 g/10 minutes (190° C., 2.16 kg) and a density of 0.89 g/cm³, 5 kg of petroleum resin, and 7 kg of an adhesive polymer compound (a ratio of

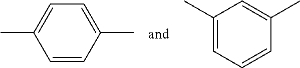

is 5:1) comprising the formula 9, roll mixing milling and extrusion are performed to prepare an adhesive resin composition with a melt index of 10 g/10 minutes (230° C., 2.16 kg). The extrusion coating of the adhesive resin composition is performed on an aluminum layer at a temperature of 230° C. by a T-die method to form a protective layer.

### Example 4

Regarding 53 kg of polypropylene with a melt index of 5 g/10 minutes (230° C., 2.16 kg), 10 kg of modified polypropylene with a melt index of 20 g/10 minutes (230° C., 2.16 kg) which is formed by a graft of a maleic acid, 20 kg of EOR (Ethylene Octene Rubber) with a melt index of 1 g/10 minutes (190° C., 2.16 kg) and a density of 0.89 g/cm³, 10 kg of petroleum resin, and 7 kg of an adhesive polymer compound (a ratio of

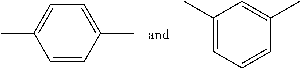

is 5:1) comprising the formula 9, roll mixing milling and extrusion are performed to prepare an adhesive resin composition with a melt index of 15 g/10 minutes (230° C., 2.16 kg). The extrusion coating of the adhesive resin composition is performed on an aluminum layer at a temperature of 230° C. by a T-die method to form a protective layer.

### Example 5

Regarding 47 kg of polypropylene with a melt index of 5 g/10 minutes (230° C., 2.16 kg), 15 kg of modified polypropylene with a melt index of 20 g/10 minutes (230° C., 2.16 kg) which is formed by a graft of a maleic acid, 25 kg of EOR (Ethylene Octene Rubber) with a melt index of 1 g/10 minutes (190° C., 2.16 kg) and a density of 0.89 g/cm³, 5 kg of petroleum resin, and 8 kg of an adhesive polymer compound (a ratio of

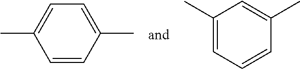

is 5:1) comprising the formula 9, roll mixing milling and extrusion are performed to prepare an adhesive resin composition with a melt index of 8 g/10 minutes (230° C., 2.16 kg). The extrusion coating of the adhesive resin composition is performed on an aluminum layer at a temperature of 230° C. by a T-die method to form a protective layer.

### Example 6

An adhesive resin composition is prepared in the same way as in Example 1 except that 10 kg of a phosphorus based flame retardant is added. The extrusion coating of the adhesive resin composition is performed on an aluminum layer at a temperature of 230° C. by a T-die method to form a protective layer.

### Example 7

An adhesive resin composition is prepared in the same way as in Example 2 except that 10 kg of a phosphorus based flame retardant is added. The extrusion coating of the adhesive resin composition is performed on an aluminum layer at a temperature of 230° C. by a T-die method to form a protective layer.

### Example 8

An adhesive resin composition is prepared in the same way as in Example 3 except that 10 kg of a phosphorus based flame retardant is added. The extrusion coating of the adhesive resin composition is performed on an aluminum layer at a temperature of 230° C. by a T-die method to form a protective layer.

### Example 9

An adhesive resin composition is prepared in the same way as in Example 4 except that 10 kg of a phosphorus based flame retardant is added. The extrusion coating of the adhesive resin composition is performed on an aluminum layer at a temperature of 230° C. by a T-die method to form a protective layer.

### Example 10

An adhesive resin composition is prepared in the same way as in Example 5 except that 10 kg of a phosphorus based flame retardant is added. The extrusion coating of the adhesive resin composition is performed on an aluminum layer at a temperature of 230° C. by a T-die method to form a protective layer.

The physical properties (processability, adhesiveness, flame retardancy and electrolyte resistance) of the protective layers of Examples 1 to 10 are evaluated. The processability is evaluated by measuring a speed range in which an adhesive strength to an aluminum layer is not lost when an extruder is constantly maintained at 100 rpm and a coating speed is gradually increased. The adhesiveness is evaluated by cutting an aluminum layer coated with a protective layer by a fixed size and measuring the peel strength of the protective layer from the aluminum layer. The flame retardancy is evaluated according to UL 94 regulations. The electrolyte resistance is evaluated by immersing an aluminum layer coated with a protective layer in an electrolyte solution of 85° C. for 24 hours, taking it out and measuring the peeling strength of the protective layer from the aluminum layer.

The protective layers formed by the adhesive resin composition of Examples 1 to 10 have a processability of 20 m/minute or more and an adhesive strength of 600 g/15 mm or more, and thus show excellent processability and adhesiveness. The protective layers maintain the adhesive strength even after the immersion in the electrolyte, and thus show excellent electrolyte resistance. In addition, the protective layers formed by the adhesive resin composition of Examples 6 to 10 are all extinguished within 30 seconds or 60 seconds and thus show excellent flame retardancy.

As above, the exemplary embodiments of the present invention have been described. Those skilled in the art will appreciate that the present invention may be embodied in other specific ways without changing the technical spirit or essential features thereof. Therefore, the embodiments disclosed herein are not restrictive but are illustrative. The scope of the present invention is given by the claims, rather than the specification, and also contains all modifications within the meaning and range equivalent to the claims.

What is claimed is:

1. A battery packaging material comprising:
a protective layer; and
a layer structure disposed on the protective layer and comprising one layer or two or more layers,
wherein the protective layer comprises an adhesive polymer compound comprising following formula 1. 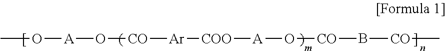
(In formula 1, Ar represents a benzene ring,
each of A and B represents a hydrocarbon group whose carbon number is 2 to 9,
—Ar— represents at least any one of 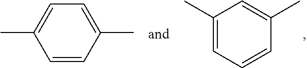
-A- represents —(CH₂)ₐ— (a is an integer of 2 or more and 9 or less), and
—B— represents —(CH₂)_{b}— (b is an integer of 2 or more and 9 or less)).

2. The battery packaging material of claim 1, wherein a ratio of 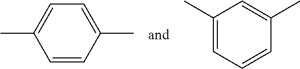
is 1:1˜10:1 in the formula 1.

3. The battery packaging material of claim 1, wherein, in the formula 1,
-A- represents at least any one of —(CH₂)₂—, —(CH₂)₃— and —(CH₂)₄—, and
—B— represents at least any one of —(CH₂)₂— and —(CH₂)₄—.

4. The battery packaging material of claim 1, wherein, in the formula 1, molecular weight of a portion corresponding to following formula 3 is 1,000˜10,000.

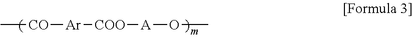

5. The battery packaging material of claim 1, wherein molecular weight of the adhesive polymer compound is 100,000˜200,000.

6. The battery packaging material of claim 1, wherein the layer structure comprises a metal layer.

7. The battery packaging material of claim 6, wherein the metal layer comprises aluminum.

8. The battery packaging material of claim 6, wherein a surface of the metal layer is treated by chrome.

9. The battery packaging material of claim 6, wherein the metal layer is in contact with the protective layer.

10. The battery packaging material of claim 6, wherein the layer structure further comprises a first adhesive layer disposed on the metal layer and a first polymer layer disposed on the first adhesive layer.

11. The battery packaging material of claim 10, wherein the first polymer layer comprises nylon.

12. The battery packaging material of claim 10, wherein the layer structure further comprises a second adhesive layer disposed on the first polymer layer and a second polymer layer disposed on the second adhesive layer.

13. The battery packaging material of claim 12, wherein the second polymer layer comprises PET.

14. A battery packaging material comprising:
a protective layer; and
a layer structure disposed on the protective layer and comprising one layer or two or more layers,
wherein the protective layer is formed of an adhesive resin composition, the adhesive resin composition comprises polypropylene, modified polypropylene, rubber, petroleum resin and an adhesive polymer compound, and the adhesive polymer compound comprises following formula 1. 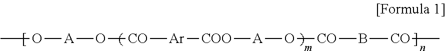
(In formula 1, Ar represents a benzene ring,
each of A and B represents a hydrocarbon group whose carbon number is 2 to 9,
—Ar— represents at least any one of 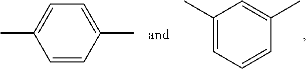
-A- represents —(CH₂)ₐ— (a is an integer of 2 or more and 9 or less), and
—B— represents —(CH₂)_{b}— (b is an integer of 2 or more and 9 or less)).

15. The battery packaging material of claim 14, wherein a ratio of 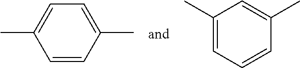
is 1:1˜10:1 in the formula 1.

16. The battery packaging material of claim 14, wherein, in the formula 1,
-A- represents at least any one of —(CH₂)₂—, —(CH₂)₃— and —(CH₂)₄—, and
—B— represents at least any one of —(CH₂)₂— and —(CH₂)₄—.

17. The battery packaging material of claim 14, wherein, in the formula 1, molecular weight of a portion corresponding to following formula 3 is 1,000˜10,000.

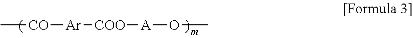

18. The battery packaging material of claim 14, wherein molecular weight of the adhesive polymer compound is 100,000˜200,000.

19. The battery packaging material of claim 14, wherein the adhesive resin composition comprises 30˜80 parts by weight of the polypropylene, 3˜15 parts by weight of the modified polypropylene, 10˜30 parts by weight of the rubber, 3˜20 parts by weight of the petroleum resin and 3˜12 parts by weight of the adhesive polymer compound.

20. The battery packaging material of claim 14, wherein the adhesive resin composition further comprises 1˜15 parts by weight of a flame retardant.

21. The battery packaging material of claim 14, wherein
the polypropylene has a melt index of 1˜10 g/10 minutes (230° C., 2.16 kg),
the modified polypropylene has a melt index of 10˜100 g/10 minutes (230° C., 2.16 kg),
the rubber has a melt index of 0.05˜10 g/10 minutes (190° C., 2.16 kg),
the adhesive polymer compound has a melt index of 1˜15 g/10 minutes (190° C., 2.16 kg), and
the adhesive resin composition has a melt index of 5˜15 g/10 minutes (230° C., 2.16 kg).

22. The battery packaging material of claim 14, wherein the modified polypropylene is formed by a graft of a maleic acid onto polypropylene.

23. The battery packaging material of claim 14, wherein the rubber comprises EPR (Ethylene Propylene Rubber), EBR (Ethylene Butene Rubber), EOR (Ethylene Octene Rubber) or a combination thereof.

24. The battery packaging material of claim 14, wherein the petroleum resin comprises C5 petroleum resin, C9 petroleum resin or a combination thereof.

25. The battery packaging material of claim 14, wherein the layer structure comprises a metal layer.

26. The battery packaging material of claim 25, wherein the metal layer comprises aluminum.

27. The battery packaging material of claim 25, wherein a surface of the metal layer is treated by chrome.

28. The battery packaging material of claim 25, wherein the metal layer is in contact with the protective layer.

29. The battery packaging material of claim 25, wherein the layer structure further comprises a first adhesive layer disposed on the metal layer and a first polymer layer disposed on the first adhesive layer.

30. The battery packaging material of claim 29, wherein the first polymer layer comprises nylon.

31. The battery packaging material of claim 29, wherein the layer structure further comprises a second adhesive layer disposed on the first polymer layer and a second polymer layer disposed on the second adhesive layer.

32. The battery packaging material of claim 31, wherein the second polymer layer comprises PET.
